(19) United States
(12) Patent Application Publication
(10) Pub. No.: US 2019/0163932 A1
(43) Pub. Date: May 30, 2019

(54) DISPLAYED INFORMATION PROTECTION SYSTEM

(71) Applicant: OBJECT RECOGNITION CANADA INC., Calgary (CA)

(72) Inventor: WILLIAM B. OLIJNYK, Calgary (CA)

(21) Appl. No.: 16/206,581

(22) Filed: Nov. 30, 2018

Related U.S. Application Data
(60) Provisional application No. 62/592,802, filed on Nov. 30, 2017.

(51) Int. Cl. G06F 21/62; G06F 21/31; G06F 21/55

(52) U.S. Cl. CPC G06F 21/6281; G06F 21/55; G06F 21/31

(57) ABSTRACT

An apparatus protecting information displayed information on a user device, the apparatus comprising: a camera aimed towards the location of a user of the user device; and a processor including: a detector in communication with the camera and the controller, detecting and communicating an event signal to the controller when the detector detects a triggering event; and a controller controlling the camera in response to signals received from the detector, wherein the controller is configured to prompts the camera to capture an image when the controller receives the event signal from the detector and sends the image in a report either directly or using a network connection to the user device or to a data storage.

### FIELD OF THE INVENTION

The present invention relates to a device protecting displayed information on a user device.

### BACKGROUND OF THE INVENTION

Unapproved access to sensitive, confidential and private information is a growing concern for many organizations in virtually every industry. Organizations may invest a significant amount of money to ensure that their networks and databases are well protected and that the transfer of information is secure. However, some weaknesses to potential threats may persist and can be overlooked. For example, organizations need a way to protect their displayed confidential information from mobile cameras that may take unauthorized photos of displays exposing confidential information. Information displayed on a screen or monitor could be captured using a camera without the detection of the information owner. Furthermore, such an image may be sent out of the organization (using email, text messaging, etc.) without an organization ever knowing.

The state of the art lacks a way to protect a screen from intrusion by a camera or unauthorized person. The prior art only tangentially confronts this problem. That is, the prior art focuses on authenticating a user, supplementing a username and password with mechanisms including verifying that only the user to whom the credentials belong is looking at the screen while the screen is displaying information that the user is authorized to access.

### SUMMARY OF THE INVENTION

A possible solution to the above problem may be a device that captures unauthorized uses of the displayed information and alerts the owner of the displayed information of such uses.

An apparatus protecting displayed information on a user device may be used, the apparatus comprising: a camera aimed towards the location of a user of the user device; and a processor including: a detector in communication with the camera and the controller, detecting and communicating an event signal to the controller when the detector detects a triggering event; and a controller controlling the camera in response to signals received from the detector, wherein the controller is configured to cause the camera to capture an image when the controller receives the event signal from the detector and to send the image in a report either directly or using a network connection to the user device or to a data storage.

In one aspect, an apparatus protecting displayed information on a user device comprising: a camera located aimed towards the location of a user of the user device; and a processor including: a facial recognition module in communication with the camera and the controller, the module detecting and communicating an event signal to the controller when the module detects a triggering event; and a controller controlling the camera in response to signals received from the detector, wherein the controller is configured to cause the camera to capture an image when the controller receives the event signal from the detector and to send the image in a report either directly or using a network connection to the user device or to a data storage.

In another aspect, an apparatus protecting displayed information on a user device comprising: a housing; a camera located within the housing aimed towards the location of a user of the user device; and a processor including: a facial recognition module in communication with the camera and the controller, the detector detecting and communicating an event signal to the controller when the module detects a triggering event; a controller controlling the camera in response to signals received from the detector, wherein the controller is configured to cause the camera to capture an image when the controller receives the event signal from the detector and to send the image in a report either directly or using a network connection to the user device or to a data storage; and a facial identification and verification module configured to lookup the facial image detected with a database of authorized user facial images.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a diagram showing the capabilities of the device.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

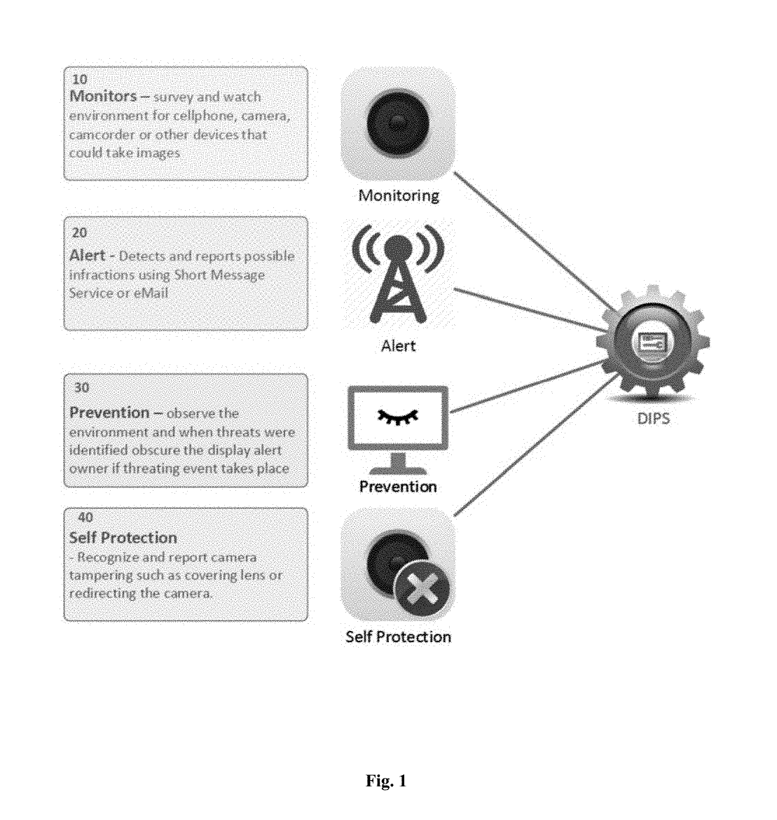

FIG. 1 illustrates at a high level the capabilities of the device to be able to protect displayed information from being compromised by threats by: 10 monitoring the environment, 20 detecting threats such as unauthorized users viewing the display or an image being taken of the display, 30 alerting the owner of the information of the event when such a threating event takes place or 40 alerting the owner of the displayed information if a manipulation threatening the integrity and function of the device takes place. To achieve this the device protecting the displayed information comprises: a housing, a camera aimed towards the location of a user of the user device; and a processor including: a detector in communication with the camera and the controller, detecting and communicating an event signal to the controller when the detector detects a triggering event; and a controller controlling the camera in response to signals received from the detector, wherein the controller is configured to prompt the camera to capture an image when the controller receives the event signal from the detector and to send the image in a report either directly or using a network connection to the user device or to a data storage.

The housing may be used to hold the camera and processor. The housing may be specific to the camera or the hardware of the apparatus. For example the shape, size and quality of camera may change the dimensions of the housing. Materials to make the housing range from relatively inexpensive plastic to more expensive aluminum or other material. The housing is optional if the apparatus is built into the display monitor or the user device.

The camera maybe located within the housing and is aimed towards the user of the device. The camera may be of any kind, lens, shape etc. in conjunction with other detection devices. A webcam may be used. The systems camera and detector use machine learning to capture images at regular intervals to detect presence of a user, and normal field of view, and “threats” which may be cameras or cell phone cameras or more than one person looking at the screen, etc. If the apparatus is used in an organization that has existing security cameras that monitor the screens then a camera may not be necessary as processor may be able to communicate directly or via network with the existing security cameras

The processor incorporates the detector and the controller. This may be a CPU that uses a processor to evaluate the trained machine learning.

The detector is used to detect changes in the environment, the detector is in communication with the camera and the controller. The detector communicates an event signal to the controller

The event signal sent to the controller when the detector detects specific changes to the environment. Using machine learning, the apparatus may be trained to distinguish features of a normal field of view and an altered field of view. The normal field of view is defined as the surroundings the camera may capture on a daily basis when the user is not present. When the user is present some of the features of the surroundings may be blocked. Once the apparatus is trained to recognize the features of the normal field of view with and without the user, then changes that may be longer lasting to the normal field of view may trigger an event signal to be sent to the controller. The apparatus may be trained to tolerate a specific range of user motions that are within a specific time range without triggering an event signal, for example if the user sneezes, or is talking on the phone or turns their attention to look at someone in the office, etc. However, if the camera is covered or unplugged then the detector will send an event signal to the controller. If the detector detects the shape of a camera, or the shape of a lens, or a posture of user holding a mobile camera device pointed in the direction of the display then the detector may send an event signal to the controller.

The controller may receive a signal from the detector and send a command the camera to take an image of the triggering event. A triggering event may be two pairs of eyes on the display, tampering with the camera, changes to the normal field of view, or photos or recordings taken of the display. The image of the triggering event may be sent using a direct connection or a network connection to the user device or to a data store. Data storage may be cloud storage, a network storage or a secure offsite data storage area. Reports stored may be unedited to protect their reliability and credibility. Detection of the triggering events sets in motion a set of pre-programmed events comprising: disabling, locking or darkening the user display; and generating a report including: an image of the triggering event, an image of the display when the triggering event took place; and the login credentials of the user. These events may take place immediately after an event signal has been transmitted to the controller. The controller may capture what is on the device screen at the time of the triggered event.

Reports generated and stored may be tracked and trends regarding the data generated may be used to help the organization develop strategic plans, develop and implement policies, educate users and to continuously improve. The reports may be generated using a log file in text format to record events. The text file will be compiled into a graphical representation of events for easy interpretation. The reports may include the camera image, the device screen capture (screen shot of the displayed information), the user logged in to the device (user name), and the device identifying information (machine name/identification).

Other benefits of the device include: deterring users from engaging in triggering events, discouraging the use of cellphones near or at a user's desk and potentially increasing a user's productivity. Furthermore the apparatus may give the public and clients confidence that confidential information is well protected. In addition, the device may prevent threats by darkening, locking or disabling the user display when a user is not present at his or her workstation or is working on something not involving the user device.

We claim:

1. An apparatus protecting information displayed on a user device, the apparatus comprising:
a camera aimed towards the location of a user of the user device; and
a processor including:
a detector in communication with the camera and the controller, detecting and communicating an event signal to the controller when the detector detects a triggering event; and
a controller controlling the camera in response to signals received from the detector, wherein the controller is configured to cause the camera to capture an image when the controller receives the event signal from the detector and to send the image in a report either directly or using a network connection to the user device or to a data store.

2. The apparatus in claim 1, wherein the triggering event is the presence of a recording or image capture of a device aimed at the user display.

3. The apparatus in claim 2, wherein the triggering event is a recoding or image capture of the user display.

4. The apparatus in claim 2, wherein the triggering event is use of the display by an unauthorized user.

5. The apparatus in claim 1, wherein the report includes the image of the triggering event, an image of the displayed information at the time of the triggering event, and login credentials of the user logged into the device at that time.

6. The apparatus in claim 1, wherein the controller is optionally configured to lock, darken or disable the display after a triggering event.

7. An apparatus protecting displayed information on a user device comprising:
a camera located aimed towards the location of a user of the user device; and
a processor including:
a facial recognition module in communication with the camera and the controller, the module detecting and communicating an event signal to the controller when the module detects a triggering event; and
a controller controlling the camera in response to signals received from the detector, wherein the controller is configured to cause the camera to capture an image when the controller receives the event signal from the detector and to send the image in a report either directly or using a network connection to the user device or to a data storage.

8. The apparatus of claim 7, wherein the detection of a triggering event generates a pre-programmed set of events comprising: disabling the host user display and generating report including an image of the triggering event, an image of the displayed information at the time of the triggering event and login credentials of the user.

9. An apparatus protecting displayed information on a user device comprising:
a housing;
a camera located within the housing aimed towards the location of a user of the user device; and
a processor including:
a facial recognition module in communication with the camera and the controller, the detector detecting and communicating an event signal to the controller when the module detects a triggering event;
a controller controlling the camera in response to signals received from the detector, wherein the controller is configured to cause the camera to capture an image when the controller receives the event signal from the detector and to send the image in a report either directly or using a network connection to the user device or to a data storage; and
a facial identification and verification module configured to lookup the facial image detected with a database of authorized user facial images.

10. The apparatus of claim 9, wherein the detection of a triggering event generates a pre-programmed set of events comprising: disabling the host user display and generating report including an image of the triggering event, an image of the displayed information at the time of the triggering event and login credentials of the user.
